(19) United States
(12) Patent Application Publication
(10) Pub. No.: US 2026/0220514 A1
(43) Pub. Date: Jul. 30, 2026

(54) DYNAMICALLY RECONFIGURABLE MULTIFUNCTIONAL QUANTUM NODES

(71) Applicant: Homatch.ai, Milpitas, CA (US)

(72) Inventor: Mingjun Wang, Saratoga, CA (US)

(21) Appl. No.: 19/456,995

(22) Filed: Jan. 22, 2026

Related U.S. Application Data
(60) Provisional application No. 63/749,285, filed on Jan. 24, 2025.

(51) Int. Cl. G06N 10/40

(52) U.S. Cl. CPC G06N 10/40

(57) ABSTRACT

A quantum processor system may include a set of quantum nodes, each node physically integrating storage, operation, and routing substructures within a single unit. The storage substructure maintains quantum states, the operation substructure performs quantum operations on these states, and the routing substructure directs quantum states between internal substructures and other quantum nodes. The nodes are operatively coupled via photonic connections and can dynamically assume different functional roles by selectively enabling or disabling their substructures. Functional roles may be dynamically reassigned at runtime based on monitored system conditions such as error states, quantum state fidelity degradation, or routing congestion.

### RELATED APPLICATION

This application claims the benefit of and priority to U.S. Provisional Application No. 63/749,285 with title “Design of Multifunctional Quantum Nodes in Double-Helix Quantum Chips” filed January 24, 2025, the entire contents of which are hereby incorporated by reference in their entirety. This application also has some subject matter relationship to U.S. Application No. 19/435,682, filed December 29, 2025, and International Application No. PCT/US26/11159, filed January 13, 2026, the contents of which are hereby incorporated by reference in their entirety.

### TECHNICAL FIELD

The present disclosure relates to multifunctional nodes in a quantum computing system.

### BACKGROUND

Unless otherwise indicated herein, the materials described herein are not prior art to the claims in the present application and are not admitted to be prior art by inclusion in this section.

A quantum computing system utilizes quantum bits (qubits), which are the fundamental unit of quantum information, implementable via multiple physical platforms such as superconducting circuits, trapped ions, photonic elements, and spin-based devices. Qubits of a system may be organized based on quantum nodes. A quantum node is an architectural unit including multiple qubits and associated control subsystems (e.g., waveform generation, timing, readout, cryogenic, and/or optical support), configured to perform a specialized function in a larger system. In distributed or modular quantum architectures, quantum nodes may be physically separated and interconnected via quantum links (e.g., photonic channels for entanglement distribution) and classical control networks.

Quantum nodes are generally designed and operated to fulfill differentiated functions or roles, such as processing, storage, and communication. Processing nodes implement gate operations and local connectivity to execute algorithmic workloads and error-correction cycles. Storage nodes emphasize long coherence time and robust state preservation to serve as quantum memory, buffering intermediate states, ancilla resources, and/or logical qubits. Communication nodes emphasize photonic interfacing, entanglement generation, heralding, and state transduction to interconnect quantum nodes over short or long links.

Such quantum computing systems with specialized quantum nodes permit each node to be optimized for respective role. However, in some implementations, specialized quantum node architectures may involve complex control protocols, calibration routines, and synchronization mechanisms, increasing system complexity and operational overhead.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some embodiments herein may relate to a quantum processor system including a set of quantum nodes, each node physically integrating storage, operation, and routing substructures within a single unit. The storage substructure maintains quantum states, the operation substructure performs quantum operations on these states, and the routing substructure directs quantum states between internal substructures and other quantum nodes. The nodes are operatively coupled via photonic connections and can dynamically assume different functional roles by selectively enabling or disabling their substructures. Functional roles may be dynamically reassigned at runtime based on monitored system conditions such as error states, quantum state fidelity degradation, or routing congestion.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates a quantum processor system including a set of multifunctional quantum nodes, in accordance with at least some embodiments of the present disclosure.

FIG. 1B illustrates the quantum processor system of FIG. 1A further including AI-assisted control layer and token-based orchestration of quantum information processing tasks, in accordance with at least some embodiments of the present disclosure.

FIG. 1C illustrates an example internal architecture of a single multifunctional quantum node in accordance with at least some embodiments of the present disclosure.

FIG. 1D illustrates an example of runtime configuration of a multifunctional quantum node in accordance with at least some embodiments of the present disclosure.

FIG. 2 illustrates an example quantum processor system, in accordance with at least some embodiments of the present disclosure.

FIG. 3 is a flowchart illustrating a method for quantum computing in accordance with at least some embodiments of the present disclosure.

FIG. 4 illustrates a three-dimensional coordinate representation of a dual-helix node layout, in accordance with at least some embodiments of the present disclosure.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the disclosure may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs or other electronic information exchanging methods. Data exchanges among devices can be conducted over a packet-switched network, the Internet, LAN, WAN, VPN, or other type of packet switched network; a circuit switched network; cell switched network; or other type of network.

The field of quantum computing has seen significant advancements in recent years. However, several challenges remain in the development of practical and scalable quantum computing systems. These challenges may include limitations in computational capacity, storage efficiency, and error correction mechanisms.

Conventional quantum computing architectures typically rely on quantum nodes specialized for individual functions such as storage, computation, or communication. Such functional specialization can impose rigid architectural constraints, limiting system flexibility and adaptability. Additionally, such discrete-function nodes may lead to inefficient utilization of chip area and complicate the integration of diverse quantum operations within a unified platform.

In some existing quantum computing designs, spatial arrangements of quantum nodes may be predominantly planar and, depending on implementation, may result in elevated levels of signal interference including crosstalk, photon loss, and decoherence. The lack of improved three-dimensional spatial distribution constrains efficient photon routing and signal isolation, which detrimentally affects quantum state fidelity and operational reliability. Traditional routing schemes often employ fixed planar pathways or static interconnects, impeding dynamic reconfiguration capabilities helpful for scalable quantum communication and computation networks.

Further, conventional systems are typically restricted with limited scalability in extending beyond two-dimensional structures, restricting the achievable qubit density and overall computational throughput. The physical layering and stacking of quantum nodes are not adequately addressed in many conventional architectures, thereby limiting three-dimensional integration and the attendant benefits of increased node density and enhanced routing complexity. Additionally, fault tolerance and error correction mechanisms may be insufficiently integrated, reducing robustness against noise and operational errors in large-scale quantum systems.

Some embodiments disclosed herein may address one or more challenges of other quantum computing systems, such as limited scalability, restricted structures and qubit density, and computational throughput. For example, one or more embodiments herein may overcome one or more of the foregoing challenges by leveraging multifunctional quantum nodes. In some embodiments, the multifunctional quantum nodes may be arranged along a double-helix (or other helical or curved) quantum chip architecture. Each quantum node integrates multiple functionalities, such as quantum state storage, quantum gate operations for single and/or multi-qubit manipulations, and dynamic photon routing capabilities. For example, the storage functionality may be implemented via optical cavities including high-reflectivity dielectric coatings and/or spin-based media such as nitrogen-vacancy centers in diamond and rare-earth ions, providing long coherence times and high-fidelity state preservation. Quantum state manipulation may be implemented by operation modules equipped with phase modulators, polarization controllers, and/or spatial light modulators for single-qubit gates, and beam splitters and/or interferometers for multi-qubit gates.

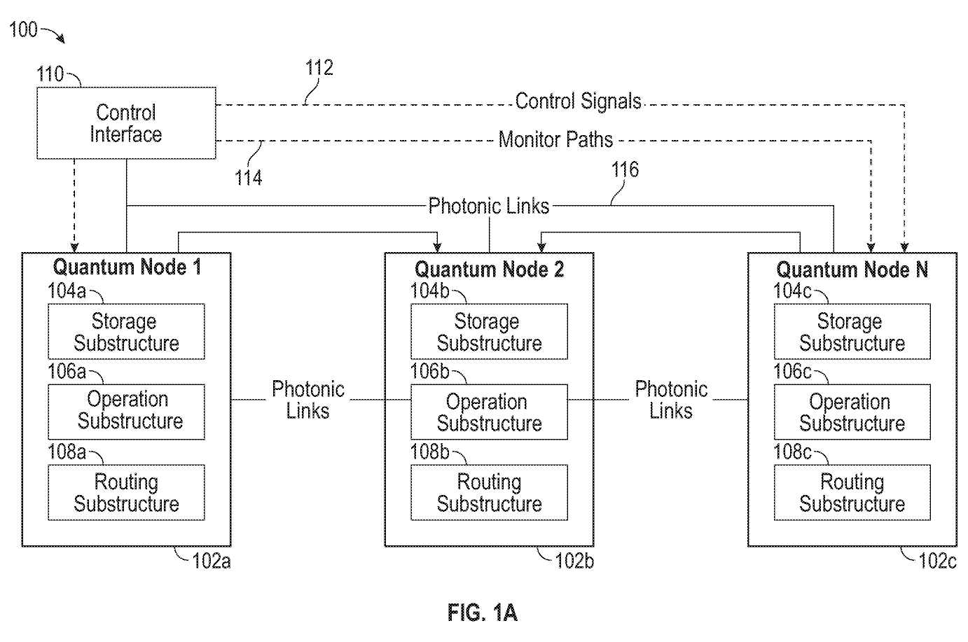

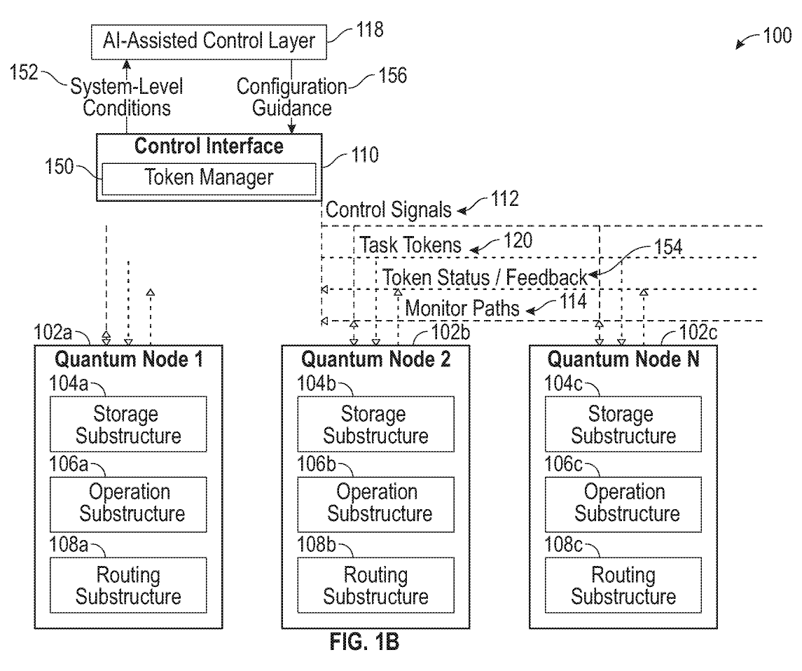

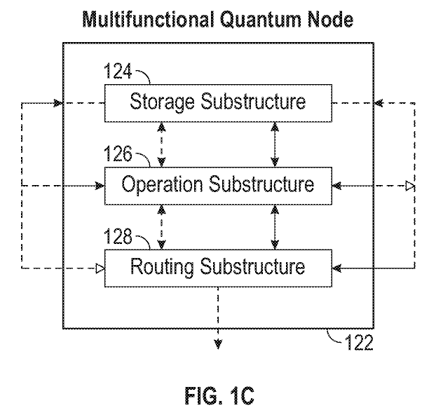

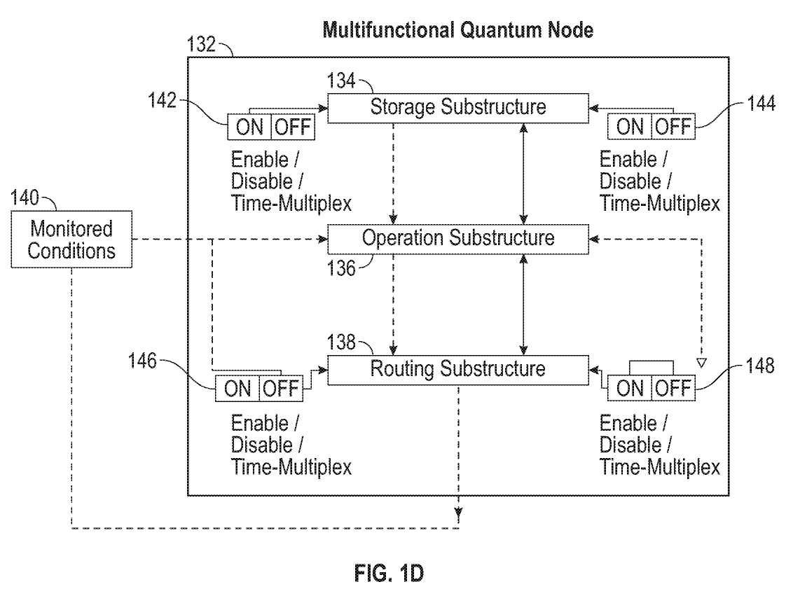

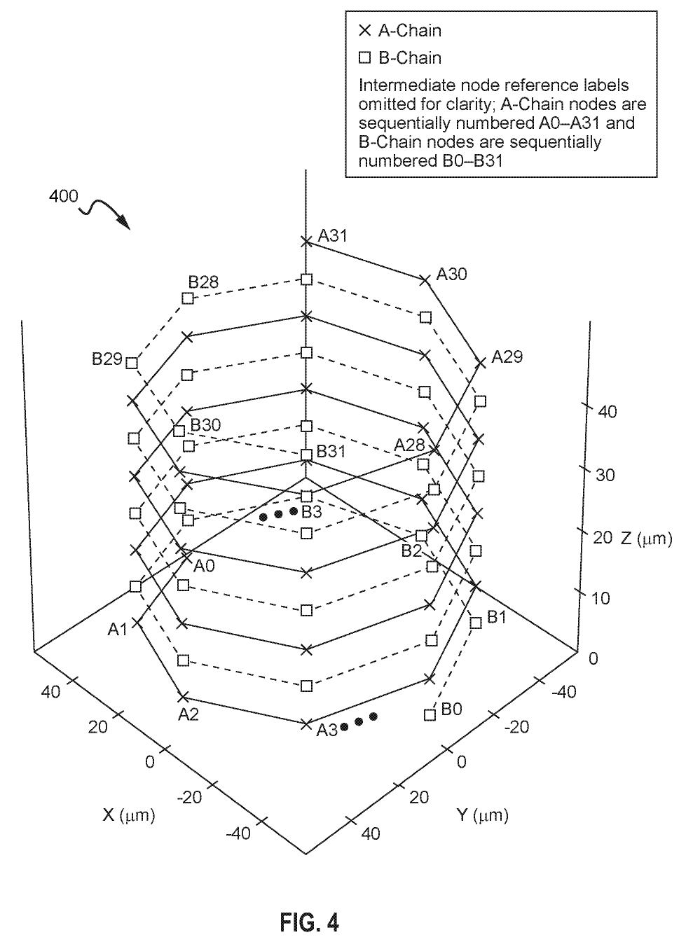

FIG. 1A illustrates an example quantum computing system 100 (system 100) including a set of multifunctional quantum nodes, in accordance with at least some embodiments of the present disclosure. In some embodiments, the plurality of quantum nodes 102 is arranged in a planar layout on a single substrate layer, and in other embodiments the plurality of quantum nodes 102 is arranged in a non-planar layout. In some embodiments, the system 100 may be implemented on a double-helix structure (or other helical or curved structure) serving as a three-dimensional geometric framework for spatially distributing the multifunctional quantum nodes. The double helix structure includes two intertwined helical strands that wind around a central longitudinal axis. Each helix supports an ordered array of quantum nodes positioned at certain three-dimensional coordinates (x, y, z) along and around the helical paths. In some embodiments, the quantum nodes located on each helix may occupy spatially distinct planes at varying heights, and the node positions along helical pattern may be selected to optimize inter-node distances and to reduce signal interference. An example double-helix layout of quantum nodes is illustrated and described in more detail with respect to FIG. 4 of the present disclosure.

For example, FIG. 4 illustrates a three-dimensional (3D) view of a dual-helix logical node layout 400, which provides a logical organization for an embodiment of the chip's layout of quantum nodes. In this depiction, the X, Y, and Z axes are annotated in micrometers, as indicated by the figure labels X, Y, and Z, respectively. The layout includes A-chain nodes, labeled A0 through A31 and denoted by crosses (A0-A31), and B-chain nodes, labeled B0 through B31 and denoted by open squares (B0-B31), each arranged along two interleaved helical paths. The A-chain and B-chain helices are offset by approximately 180 degrees at each Z level, resulting in paired A and B nodes at the same vertical (Z) position in 3D space. This arrangement visually represents the logical adjacency and pairing of A and B nodes at each height, as well as the nearest-neighbor connections along each helix, as shown by the spatial relationships among the labeled nodes in the figure.

The phrase "dual-helix logical node layout," as used herein, refers to an arrangement of quantum nodes in 3D space in which two interleaved chains of nodes follow helical paths, with each chain offset from the other by a fixed angular phase. The purpose of the dual-helix logical node layout is to provide a logical framework for organizing quantum nodes. In one example, some nodes are identified as part of an "A-chain" and other nodes are identified as part of a "B-chain". "A-chain" and "B-chain" are simply labels for organizing nodes in a manner that is inspired by a first helix and a second helix of a dual helix structure. In various examples presented herein, nodes are arranged in a manner that provides adjacency between at least some nodes along a given "chain" and between some nodes in different chains. Arrangements derived from a helical or dual helical organization in accordance with examples of the present disclosure can support efficient photonic routing and scalable quantum processor architectures. Examples of dual-helix logical node layouts may include, without limitation, arrangements in which the A-chain and B-chain nodes are paired at each vertical position, and each chain supports nearest-neighbor connections along the helical path. The term "logical" is used herein to clarify that the node organization defined in 3D space is distinct from the physical layout of node cores described in two-dimensional (2D) space for various embodiments described herein.

With reference back to FIG. 1A, the system 100 includes a set of multifunctional quantum nodes communicatively coupled by photonic connections. For example, the system 100 includes a first quantum node 102a, a second quantum node 102b, and a third quantum node 102c (collectively referred to as quantum nodes 102). The third quantum node 102c may represent the nth quantum node of the set of quantum nodes, and the system 100 may include any suitable number of quantum nodes. The system further includes a control interface 110 configured to transmit control signals 112 that configure different substructures of the quantum nodes 102. The control interface 110 may implement dynamic reconfiguration of the functional role of each quantum node, such as storage, operation, and/or routing.

The control signals 112 may be generated and managed via centralized controllers, distributed controllers, and/or local control circuitry embedded within the quantum nodes 102. The control interface 110 leverages monitoring information indicative of quantum state fidelity, routing congestion, and/or node health to adaptively modify node configurations in real-time. The control interface 110 receives the monitoring information via monitor paths 114. In some embodiments, the control signals 112 may be routed via dedicated control layers or interconnects that are spatially separated from photonic interconnect structures. The physical separation may reduce electromagnetic interference and crosstalk, thereby improving the stability and reliability of quantum operations. The control interface 110 refers to a physical and/or logical component configured to facilitate quantum operations with respect to the quantum nodes 102. The control interface 110 may be implemented as dedicated hardware circuitry, such as a microcontroller unit, a field-programmable gate array (FPGA), or an application-specific integrated circuit (ASIC), designed to generate and transmit the control signals 112. In some embodiments, the control interface 110 may include software-defined control logic executed on classical computing hardware, interfacing with the quantum hardware via electronic or optical interconnects.

The quantum nodes 102 are communicatively coupled based on photonic links 116. The photonic links 116 between the quantum nodes 102 facilitate high-fidelity quantum state transfer and entanglement distribution within the system 100. The photonic links 116 may be embodied as low-loss optical waveguides formed in or on a substrate of the system 100 (e.g., waveguides fabricated from silicon nitride (SiN), silicon, lithium niobate, or other suitable photonic materials). In some embodiments, integrated couplers within a waveguide network implement photon transitions between nodes residing on the system 100 (e.g., along a double-helix structure), including transitions between nodes on a same helix and across adjacent helices, supporting flexible routing configurations in three-dimensional space. Additionally, vertical or inter-layer coupling elements, such as optical switches, vertical couplers, or grating couplers, may extend the photonic links 116 between different layers in multi-layer quantum chip designs, ensuring scalable inter-node communication across planar and stacked arrangements including embodiments in which the quantum nodes 102 are arranged in a planar layout.

The quantum nodes 102 each include a set of substructures or distinct, physically integrated functional components, each substructure configured to perform a specific role for quantum information processing. The set of substructures may permit each quantum node to operate as an independent quantum unit capable of various operations. In these and other embodiments, each quantum node may include a storage substructure, an operation substructure, and a routing substructure. For example, the first quantum node 102a includes a first storage substructure 104a, a first operation substructure 106a, and a first routing substructure 108a. The second node 102b includes a second storage substructure 104b, a second operation substructure 106b, and a second routing substructure 108b. The third node 102c includes a third storage substructure 104c, a third operation substructure 106c, and a third routing substructure 108c. The substructures may be described in further detail with respect to FIG. 1C of the present disclosure.

In some embodiments, the quantum nodes 102 may be implemented using integrated photonic components. In other embodiments, the quantum nodes may be implemented based on a hybrid architecture combining photonic elements with spin-based quantum memory elements, such as nitrogen vacancy centers in diamond or rare-earth ions.

In some embodiments, the system 100 may incorporate an artificial intelligence (AI)-assisted control layer configured to orchestrate the operation of quantum nodes 102 based on a token-based representation of quantum information processing tasks. For example, FIG. 1B illustrates the system 100 incorporating the AI-assisted control layer 118. In some embodiments, the AI-assisted control layer 118 may be coupled to the control interface 110 and/or a token manager 150 configured to generate, distribute, and manage task tokens 120 representative of quantum storage, computation, and routing requests.

Monitoring information and other system-level conditions 152, including token status and feedback 154 from the quantum nodes 102, may be provided to the AI-assisted control layer 118. In response, the AI-assisted control layer 118 may output configuration guidance 156 that influences assignment, deferral, or redistribution of the task tokens 120 among the quantum nodes 102. The AI-assisted control layer 118 operates without directly performing quantum operations and/or imposing deterministic algorithmic scheduling. For example, the configuration guidance 156 influences generation and/or application of control signals 112 that modulate activation, deactivation, and/or time-multiplexing of the storage substructures 104, the operation substructures 106, and the routing substructures 108 without performing quantum operations.

In some embodiments, the system-level conditions 152 may be communicated to the AI-assisted control layer 118 from a token manager 150. The token manager 150 is a subsystem of the control interface 110 configured to represent and manage quantum tasks via tokenization. The token manager 150 is configured as the interface for task abstraction and distribution such that the quantum operations are expressed as manageable tokens for orchestration. Some functions of the token manager 150 may include token generation (e.g., create the task tokens 120), token distribution (e.g., assign tokens to appropriate quantum nodes based on the system state and AI-assisted guidance), lifecycle management (e.g., track token status, monitor execution progress, and/or handle deferrals or redistributions), feedback integration (e.g., collect execution feedback from nodes and relay to the AI-assisted control layer 118), etc.

FIG. 1C illustrates an example internal architecture of a single multifunctional quantum node 122 (quantum node 122). The quantum node 122 may correspond to the first node 102a, the second node 102b, and/or the third node 102c of FIG. 1A. The quantum node 122 includes a storage substructure 124 (corresponding to the first storage substructure 104a, the second storage substructure 104b, and/or the third storage substructure 104c of FIG. 1A), an operation substructure 126 (corresponding to the first operation substructure 106a, the second operation substructure 106b, and/or the third operation substructure 106c of FIG. 1A), and a routing substructure 128 (corresponding to the first routing substructure 108a, the second routing substructure 108b, and/or the third routing substructure 108c of FIG. 1A).

Each substructure is physically implemented as a dedicated region or module of the quantum node 122 and is structurally equipped to perform a corresponding function. Internal optical paths, waveguides, resonant interfaces, and/or coupling elements may permit quantum states to be transferred between the storage substructure 124, the operation substructure 126, and the routing substructure 128 within the boundaries of the quantum node 122.

The quantum node 122 is architected to dynamically assume different functional roles—storage, operation, routing, or combinations thereof—by selectively enabling, disabling, or time-multiplexing the physically integrated substructures within a single physical unit. In some embodiments, the control interface (e.g., the control interface 110 of FIG. 1A) may transmit control signals to the quantum node 122 to configure internal coupling paths, switches, modulators, and corresponding interfaces to activate or deactivate one or more substructures according to system requirements or monitored conditions.

In some embodiments, the role of the quantum node 122 may be configured to alternate between different roles based on different time intervals. For example, the quantum node may switch between the storage role, the operation role, and the routing role as configured by the control interface. In some embodiments, runtime role reassignment may be responsive to monitored parameters such as error states, fidelity degradation, or routing congestion, permitting adaptive fault-tolerant operation. Internally configurable coupling paths may permit reconfiguration of the roles without physical modification or quantum state transfer to separate nodes.

The storage substructure 124 is configured to maintain quantum states with high fidelity over a selectable duration, thereby serving as a dedicated quantum memory region within the quantum node 122. The storage substructure 124 includes physical materials, devices, and coupling interfaces that collectively support long coherence times and stable quantum state preservation.

In some embodiments, the storage substructure 124 may include one or more high-quality-factor (high-Q) optical cavities, resonators, and/or equivalent photonic confinement structures configured to temporarily confine photonic qubits. The confinement is achieved based on circulation of photons or repeated reflection of the photons within a defined cavity volume. The photonic qubits stored within such cavities may be encoded in one or more quantum degrees of freedom, including but not limited to optical phase, polarization, orbital angular momentum (OAM), frequency, time-bin encoding, or combinations thereof. Tunable couplers, optical switches, or resonant interfaces control the coupling between the storage cavity and internal photonic waveguides, selectively admitting quantum states into the cavity during write operations and releasing them during read operations.

Additionally or alternatively, particularly in hybrid photonic-spin architectures, the storage substructure 124 may include spin-based quantum memory elements, such as nitrogen-vacancy (NV) centers in diamond, rare-earth ions, or other solid-state spin systems known for extended coherence times. In such hybrid photonic–spin architectures, photon-to-spin transduction interfaces facilitate the transfer of quantum state information between photonic carriers and spin- based memory elements. Incoming photonic qubits are received via internal waveguide connections, transduced into spin states through optical, microwave, or electromagnetic coupling mechanisms, stored for extended durations, and subsequently retrieved and converted back into photonic qubits. The hybrid configuration implements compatibility between high-speed photonic interconnects and long-lived quantum memory within a single quantum node.

The storage substructure 124 is operatively coupled to the operation substructure 126 and the routing substructure 128 via internally defined coupling paths, such as integrated optical waveguides or resonant interfaces. The coupling paths are configurable, permitting the controlled transfer of quantum states into the storage substructure 124 for preservation, isolation of stored states to prevent unwanted interactions during storage, and forwarding of quantum states to the operation substructure 126 and/or the routing substructure 128 upon retrieval. In the storage phase, the storage substructure 124 may be electrically, optically, and/or thermally isolated from active substructures to mitigate noise, reduce decoherence, and prevent interference. Such isolation may be achieved based on deactivating modulators, adjusting coupling coefficients, detuning resonant elements, and/or physically shielding sensitive components, among others.

In instances in which the quantum node 122 is assigned the storage role, the control signals 112 may configure the quantum node 122 to channel incoming quantum states directly into the storage substructure 124 and bypass the operation substructure 126 via internal routing paths. Concurrently, processing components within the quantum node 122 may be reduced in activity or disabled to reduce perturbations to the stored quantum information. With respect to the storage role, the quantum node 122 functions as a high-fidelity quantum memory element, maintaining quantum states for durations that may be dynamically controlled according to system requirements, workload conditions, or embedded error correction protocols.

To support fault tolerance, the storage substructure 124 may be configured to participate in distributed logical qubit encoding schemes in which logical qubits are redundantly encoded across multiple storage substructures located in spatially separated quantum nodes. Such physical separation reduces the likelihood of correlated noise and improves overall fault tolerance of the quantum system. Additionally, the storage substructure 124 may be configured to temporarily store ancillary qubits or intermediate quantum states utilized in quantum error detection, correction, or verification processes.

The operation substructure 126 is configured to perform quantum state manipulation and execution of quantum operations on quantum states received either from the storage substructure 124, external routing paths, or a combination thereof. Physically realized quantum control components are co-located with the other substructures and coupled via internal optical or electromagnetic interfaces, implementing quantum state transfer and processing within the boundaries of the quantum node 122 without communication with separate processing units.

In photonic and hybrid implementations, the operation substructure 126 may incorporate various quantum control components such as phase modulators designed to impart controlled phase shifts, and polarization controllers configured to rotate or transform polarization-encoded quantum states. Additionally, the operation substructure 126 may include beam splitters configured to divide and recombine photonic paths to facilitate quantum interference, interferometric structures such as Mach–Zehnder interferometers configured to perform conditional quantum transformations, and spatial light modulators or equivalent mode-control devices configured to manipulate spatial modes or orbital angular momentum states. Such components may be fabricated, bonded, or co-packaged within the quantum node 122 and interconnected through internal waveguides, resonant interfaces, or coupling pathways.

In instances the quantum node 122 is configured in and/or assigned the operation role, the control signals 112 direct quantum states internally towards the operation substructure 126. In such configuration, stored quantum states become accessible for processing, inputs arriving from routing paths may be processed immediately, and processed quantum states may be forwarded to the storage substructure 124 and/or communicated onward to other quantum nodes. The storage substructure 124 may temporarily be bypassed or utilized as an intermediate buffer handling ancillary states or partial computational results.

The operation substructure 126 may be configured to facilitate single-qubit quantum operations such as phase shifts, rotations within polarization or spatial-mode spaces, and basis transformations. Control signals applied to modulators and controllers dictate the specific quantum transformations executed on physical carriers of quantum information, including photons or spin states contained within the quantum node 122.

Additionally or alternatively, the operation substructure 126 may be configured to execute multi-qubit quantum operations. The multi-qubit quantum operations may include controlled operations implemented via physical interaction mechanisms such as photon–photon interference at beam splitters, path-dependent interference within interferometric arrangements, or mediated interactions utilizing auxiliary modes, ancilla pathways, or coupling elements. In various implementations, multi‑qubit photonic gates may be probabilistic but heralded (e.g., measurement‑induced linear‑optical schemes using ancilla photons and detection) and/or may be implemented deterministically via mediated interactions (e.g., using matter‑based ancilla, cavity‑enhanced nonlinearities, or spin‑photon interfaces), depending on the physical platform. In these and other embodiments, the quantum states associated with multiple qubits may be temporally or spatially synchronized internally to enable coherent interactions capable of realizing operations such as controlled-phase or controlled-NOT gates.

In some embodiments, the operation substructure 126 may be selectively coupled to the storage substructure 124 and the routing substructure 128 via configurable internal coupling paths. The selective coupling permits retrieved quantum states from storage to enter the operation substructure 126 for processing, immediate processing of arriving quantum states from routing paths, and forwarding of processed quantum states back to routing paths. In some instances in which the quantum node is assigned or configured to operate as an operation node, the routing substructure 128 may be partially disabled or configured for simple forwarding of quantum states, while the storage substructure 124 can act as a buffer for intermediate or ancillary quantum states. Such configurations may reduce decoherence and quantum information loss by reducing unnecessary transfers.

Assignment and activation of the operation role are achieved through configuration of internal switches, modulators, and coupling elements responding to applied control signals. The signals may determine the physical components of the operation substructure 126 to remain active, the internal routing paths for quantum states, and the specific sequences or types of quantum operations to be performed. In some instances, the operation substructure 126 may be engaged on a temporary, repeated, or intermittent basis, permitting the quantum node 122 to alternate among operation, storage, and routing functionalities.

In some embodiments, the operation substructure 126 may actively participate in error detection and error correction routines, including syndrome extraction and verification procedures. In response to the monitored operational parameters indicating degradation in performance and/or fidelity within the operation substructure 126, the quantum node 122 can dynamically reassign the current role away from processing toward storage or routing functions. The dynamic reassignment capability may improve robustness at the system level and facilitate adaptive workload balancing within the quantum processor architecture.

The routing substructure 128 is configured to direct quantum states to, from, and through the quantum node 122, permitting controlled quantum state propagation internally and between distinct quantum nodes of the quantum processor system. The routing substructure 128 may physically include photonic transport and switching components co-located with other substructures and coupled via internal waveguides or coupling interfaces. The integration facilitates redirection of quantum states within the boundaries of the quantum node 122, obviating the need to transfer quantum states to a separate physical routing node.

In photonic and hybrid embodiments, the routing substructure 128 may include multiple physically integrated components, such as low-loss optical waveguides such as silicon nitride waveguides configured to transport photonic qubits with minimal attenuation. Tunable optical couplers selectively couple photons between waveguides or distinct routing paths, permitting dynamic control of photon flow. Optical switches provide the capability to direct photons along chosen paths, supporting flexible routing schemes. Vertical or inter-layer coupling elements enable routing of quantum states between different layers of a multi-layer or three-dimensional quantum processor architecture, facilitating three-dimensional scalability. Isolation and filtering elements suppress back-reflection, crosstalk, and undesired mode coupling, preserving quantum coherence and signal integrity. In some embodiments, the waveguides, couplers, and optical switching elements are configured to preserve coherence of routed photonic qubits by maintaining low insertion loss and low back‑reflection and by controlling phase and polarization stability (e.g., low added phase noise and/or path‑length‑matched or phase‑compensated routing). Such components may be fabricated, bonded, or co-packaged within the quantum node to form a configurable internal routing network.

In instances in which the quantum node 122 is configured to perform a routing role, the control signals 112 may activate the routing substructure 128 to permit quantum states to traverse the quantum node 122 with reduced processing. In the routing role, the quantum states may be forwarded directly between other quantum nodes or quantum processor layers, with routing paths selected or adjusted according to prevailing system conditions such as congestion or detected faults. In such instances, the quantum node 122 functions as a quantum communication or relay element facilitating photon transfer within the quantum processor system. Activation of the routing role may result from system-level configuration decisions, localized routing congestion, or malfunction of neighboring quantum nodes.

The routing substructure 128 may provide internal connectivity among the storage substructure 124 and the operation substructure 126 and external photonic connections. Quantum states may be routed from an external photonic interface into the storage substructure 124 for memory operations, from the storage substructure 124 to the operation substructure 126 for quantum gate execution, from the operation substructure 126 back to the storage substructure 124 or onward to other quantum nodes, or directly through the quantum node 122, operating as a relay. Routing paths are determined by configuring internal switches, couplers, or waveguide intersections embedded within the routing substructure.

In some embodiments, inter-node communication may be supported by the routing substructure 128 directing quantum states between different quantum nodes of the quantum processor system. In embodiments employing non-planar or multi-layer architectures, vertical and inter-layer coupling elements may permit quantum states to transition between layers and maintain coherence, thereby supporting scalable quantum processor designs with nodes distributed across multiple spatial planes.

In some embodiments, the routing paths are dynamically adjustable based on monitored conditions including photon routing congestion, increased loss on particular paths, or degradation or failure of neighboring nodes. Dynamic adjustment mechanisms include re-selecting waveguide paths, tuning coupling strengths, bypassing compromised routes, and rerouting quantum states through alternative nodes.

In instances in which the quantum node is transitioning between storage, operation, and routing roles, the routing substructure 128 may reconfigure internal routing paths to isolate inactive storage substructure 124 and/or operation substructure 126, direct quantum states to active substructures, or operate as a pass-through relay. In these and other embodiments, the reconfigurations occur without physical modification of the quantum node 122 and avoid unnecessary quantum state transfers to external nodes.

In some embodiments, the quantum node 122 operates in time-multiplexed modes, alternating between storage, operation, and routing functionalities during different intervals. In other embodiments, the quantum node 122 may operate with limited overlap of multiple roles, such as routing quantum states via the routing substructure 128 and temporarily buffering intermediate states in the storage substructure 124. The reconfiguration and/or reassignment of the roles may be described in further detail with respect to FIG. 1D of the present disclosure.

In some embodiments, the quantum node 122 and associated interconnect structures may be fabricated based on diverse lithographic, deposition, and etching techniques. Some examples may include, multi-photon lithography, electron-beam lithography, photolithography, and/or related thin-film processing approaches, among others. The disclosed architectures are material-agnostic and compatible with photonic, superconducting, spin-based, or hybrid quantum technologies. Fabrication may be performed on a monolithic substrate, a set of bonded substrates, or within co-packaged modules, provided that the storage substructure 124, the operation substructure 126, and the routing substructure 128 remain structurally and functionally unified within each quantum node.

In some embodiments, each substructure may be designed, fabricated, and optimized individually as a distinct hardware block prior to integration. In these and other embodiments, the quantum node 122 may constitute a modular system-on-chip architecture, in which each substructure performs a specialized function and maintains coupling based on internal photonic or electromagnetic interfaces.

An internal interconnect architecture within the quantum node provides connectivity among the storage, operation, and routing substructures. Such architecture may include, for example, a shared photonic interconnect (e.g., a waveguide ring, a waveguide spine, an optical bus, etc.). The routing substructure 128 may implement a local switch fabric coupled to this internal bus; the storage substructure 124 may connect via tunable coupling interfaces; and the operation substructure 126 may interface via switchable or tunable coupling elements.

FIG. 1D illustrates a runtime configuration of a multifunctional quantum node 132 (quantum node 132), in accordance with at least some embodiments of the present disclosure. The quantum node 132 may correspond to the quantum nodes 102 of FIG. 1A and/or the quantum node 122 of FIG. 1C. The quantum node 132 is configured to dynamically reconfigure the functional role at runtime by selectively enabling, disabling, or time-multiplexing the integrated storage substructure 134, operation substructure 136, and routing substructure 138. Such runtime reconfiguration may be realized through adjustment of internal coupling pathways, switches, modulators, and control interfaces within the single physical quantum node.

For example, the quantum node 132 includes one or more switches configured to control the substructures. For example, the quantum node 132 may include a first switch 142, a second switch 144, a third switch 146, and a fourth switch 148 located at the boundaries of the substructures. The switches may be configured to respond to control signals generated based on the monitored conditions 140 (e.g., error states, fidelity degradation, routing congestion, etc.). In these and other embodiments, the switches may be configured to control whether quantum states are admitted into or bypass certain substructures based on the monitored conditions 140. For example, disabling the switches at the boundaries of a substructure, the quantum state may be prevented from entering or exiting the substructure.

In some embodiments, the switches may be located at the boundaries of the substructures to implement directional control of the quantum states. For example, the first switch 142 and the third switch 146 may be located along a first or left boundary of the substructures, and the second switch 144 and the fourth switch 148 may be located along a second or right boundary of the substructures. The first switch 142 and the second switch 144 may be coupled to the storage substructure 134, and the third switch 146 and the fourth switch 148 may be coupled to the operation substructure 136 and the routing substructure 138. The dual switches, one at each boundary, may provide directional control in which quantum states may be permitted to be admitted for storage or routed onward. The paired switches may support flexible switching schemes permitting transitions between functional roles. In some embodiments, the switches may be modulated to alternate active substructures over discrete time intervals.

In some embodiments, the runtime role reassignment is triggered based on monitored conditions indicative of system performance or operational health. Some examples of such monitored conditions may include detection of error states associated with quantum states, components, or substructures, degradation in quantum state fidelity, coherence time, or signal quality, congestion or elevated loss within photon routing paths, and/or changes in system-level workload or resource distribution, among others. Monitoring data may be obtained from internal sensors, feedback loops, photonic monitoring elements, or control interface outputs associated with the quantum node or overarching quantum processor system.

Based on the detection of such monitored conditions, control signals from the control interface (e.g., the control interface 110 of FIG. 1A) modify the configuration of the quantum node 132 based on activation or deactivation of specific substructures and adjustments of the internal routing of quantum states. For example, the quantum node 132 may transition from an operation role to a routing role to bypass compromised processing pathways, from a routing role to a storage role to temporarily preserve quantum information, or to reactivate the operation substructure 136 in response to completion of recovery or recalibration procedures. The transitions may be implemented based on reconfiguring internal optical paths, tuning coupling coefficients, selectively enabling modulators or switches, and/or modulating isolation among substructures, occurring within the unchanged physical boundary of the quantum node 132.

In some embodiments, the quantum node 132 may operate on a time-multiplexed basis, sequentially assuming distinct functional roles in discrete time intervals. For example, the quantum node 132 may store quantum states in a first period, perform quantum operations in a subsequent interval or a second period, and act as a routing element in a third period. In some embodiments, the quantum node 132 may assume multiple roles at the same time with limited functional overlap. For example, the quantum node 132 may route quantum states and buffer intermediate quantum information in the storage substructure 134 simultaneously. The extent of such overlap may be defined based on configurable internal coupling and isolation mechanisms.

The capability for dynamic role reassignment may be implemented based on the physical integration and independent controllability of the storage substructure 134, the operation substructure 136, and the routing substructure 138 within the quantum node 132. Each substructure is structurally present and accessible, permitting the quantum node 132 to perform any functional role without dependence on external or separate physical nodes. The integrated architecture contrasts with conventional quantum systems, in which functional reassignment requires transferring quantum states between physically distinct, task-specialized nodes.

In some embodiments, the quantum node 132 may be configured to implement error detection and fault-tolerant operations. For example, the quantum node 132 may implement monitoring and diagnostic mechanisms with respect to the storage substructure 134, the operation substructure 136, and the routing substructure 138. The mechanisms may include monitoring and detection of error conditions such as loss or degradation of quantum state fidelity, increased decoherence or reduced coherence times, malfunctions or drift in quantum control components, and elevated loss or interference in photonic routing paths, etc. In some embodiments, the detection may be accomplished based on measurement of ancillary qubits, parity checks, syndrome extraction protocols, monitor taps on waveguides, or feedback signals generated by internal sensing apparatus.

In response to the detection of one or more error conditions, one or more error correction and mitigation techniques may be implemented. The techniques may be designed to preserve quantum information fidelity and sustain coherent operations. Some examples of the error correction and mitigation techniques include Shor codes, Steane codes, surface codes, other stabilizer-based or redundancy-oriented schemes.

Shor codes employ concatenated encoding strategies protecting logical qubits against arbitrary single-qubit errors by combining bit-flip and phase-flip error correction within a nine-qubit repetition framework. Steane codes utilize seven-qubit CSS (Calderbank-Shor-Steane) encoding to achieve fault-tolerant error correction with fewer qubits, providing efficient logical qubit protection against common noise channels. Surface codes represent topological error correction methods that arrange qubits on a lattice implementing high error thresholds and scalable correction through local syndrome measurements.

Error mitigation techniques may include one or more methods that reduce the impact of decoherence and operational noise without requiring full QEC overhead, generally by leveraging probabilistic error cancellation, extrapolation methods, or dynamical decoupling sequences.

In some embodiments, the error correction techniques may be executed locally within the operation substructure 136 of the quantum node 132. For example, the operation substructure 136 facilitates syndrome extraction and corrective gate operations directly on the node’s physical qubits, thereby limiting the need for quantum state transfer between nodes and reducing associated latency and decoherence risks.

Additionally or alternatively, the error correction techniques may be performed cooperatively across multiple quantum nodes, in which syndrome measurements and logical qubit encoding span spatially separated nodes. The cooperative approach may permit distributed logical qubit protection, improve fault tolerance via spatial redundancy, and support correction of correlated errors that may affect qubit clusters. Coordination between nodes for syndrome extraction and correction feedback is facilitated via photonic interconnects and control interfaces, allowing synchronization and cooperative error management without centralized bottlenecks.

In some embodiments, error detection and fault tolerance mechanisms may be intrinsically linked with the runtime reconfiguration and role reassignment functionalities of the multifunctional quantum nodes. For instance, in response to identifying an error condition or a degradation in performance within a particular substructure, such as the operation substructure 136, control interface dynamically reassigns the quantum node 132 to an alternative functional role, for example, routing or storage. The reassignment is performed within the existing physical node architecture, permitting other quantum nodes within the processor system to compensate for the affected functionality. In parallel, photon routing paths may be adaptively modified to circumvent nodes or interconnects demonstrating elevated error rates, thereby maintaining overall quantum state fidelity and system reliability.

In some embodiments, the control interface of the quantum processor system (e.g., the control interface 110 of FIG. 1A) may be configured to collect and aggregate error detection data generated by the storage substructures, the operation substructures, and/or the routing substructures within individual quantum nodes distributed throughout the quantum processor system, including the quantum node 132. The aggregation process compiles monitoring information such as detected quantum state fidelity losses, error syndromes from quantum error correction protocols, component performance metrics, and routing path degradation indicators from the individual quantum nodes. The control interface may facilitate comprehensive error diagnostics based on the aggregated error detection data.

Aggregation at the node or control interface level permits real-time synthesis of error-related information, providing actionable insights to the control logic for adaptive response. For example, the control interface may trigger runtime role reassignments, adjust photon routing paths to circumvent compromised nodes, and/or reallocate computational workloads across the individual quantum nodes dynamically based on the aggregated error detection data. The distributed collection and centralized aggregation scheme ensure scalable monitoring without overwhelming communication channels, thereby maintaining low-latency feedback critical for quantum coherence preservation.

In some embodiments, the control interface may identify and isolate the quantum nodes experiencing the issues or errors. For instance, in response to identifying quantum nodes exhibiting error conditions, performance degradation, and/or operational anomalies, the control interface initiates isolation procedures for the affected quantum nodes. The isolation procedures may include selectively disabling or bypassing the malfunctioning substructures within the quantum nodes based on coordinated control signals that reconfigure internal coupling paths, switches, and/or modulators. Additionally or alternatively, the control interface may coordinate with other system components to reroute photonic quantum states around isolated nodes via alternative routing paths or nodes, maintaining continuous quantum information processing despite localized faults.

In some embodiments, the aggregate error detection data may be used as a foundational input for advanced system management techniques, such as predictive maintenance and load-balancing strategies. Predictive maintenance algorithms may analyze trends and patterns within the collected monitoring information to forecast potential component failures or performance declines prior to occurrences of critical faults. The foresight permits preemptive corrective actions, such as recalibration of quantum control components, realignment of optical couplings, or proactive reassignment of functional roles among quantum nodes, thereby minimizing unplanned downtime and preserving quantum coherence.

Additionally or alternatively, load-balancing strategies may utilize the aggregated data to assess system-wide workload distribution and/or to identify nodes or substructures experiencing elevated operational stress, congestion, or error rates. The system may improve resource utilization based on the aggregated data by dynamically reallocating quantum information processing tasks, adjusting photon routing paths, and/or selectively assigning redundant nodes based at least on the aggregated data.

In some embodiments, the quantum node 132 or the control interface of the quantum node 132 may be configured to collect and aggregate the error detection data collected from individual quantum nodes. Such system-level coordination facilitates dynamic redistribution of quantum workloads across multiple nodes to balance resource utilization and maintain operational continuity. Activation of redundant nodes or substructures is employed to replace or supplement nodes exhibiting degraded performance, while system protocols support graceful degradation of performance metrics rather than abrupt or catastrophic system failures. The capability of each quantum node to physically perform storage, operation, and routing functions enables this flexible fault-tolerant strategy without necessitating dedicated spare nodes assigned to specific functional roles. Consequently, the quantum processor system achieves enhanced robustness, resilience, and scalable fault tolerance through integrated detection, reconfiguration, and workload reallocation mechanisms.

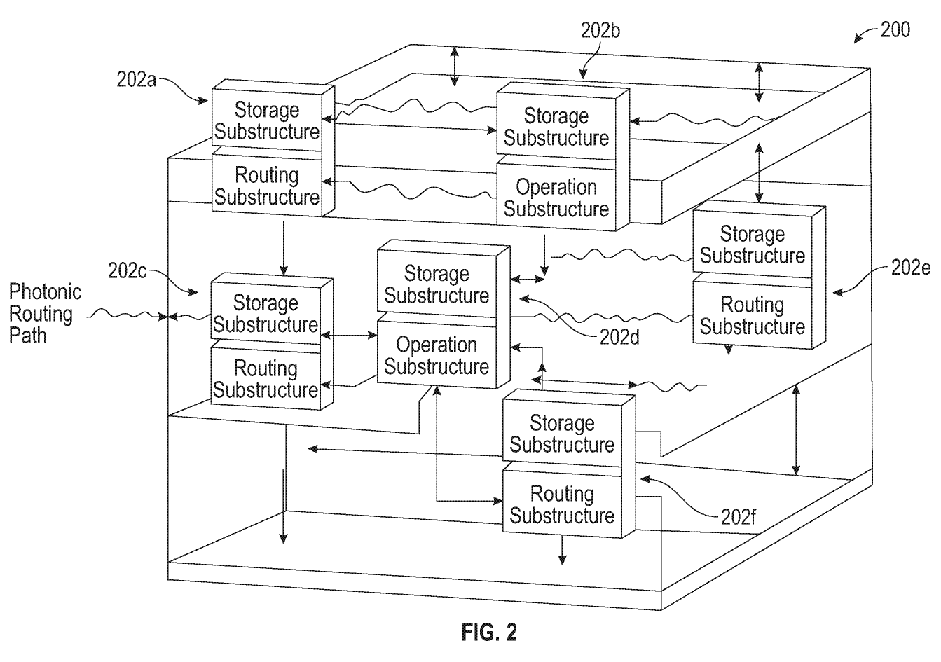

FIG. 2 illustrates an example quantum processor system 200 (system 200), in accordance with at least some embodiments of the present disclosure. In particular, the system 200 may illustrate embodiments employing non-planar and/or multi-layer arrangements of quantum nodes. The system 200 may be an example embodiment of the system 100 of FIG. 1A. For example, the quantum nodes 102 of FIG. 1A may be arranged as illustrated with respect to the system 200.

The system 200 includes a set of quantum nodes placed across multi-layers. For example, the system 200 includes a first quantum node 202a, a second quantum node 202b, a third quantum node 202c, a fourth quantum node 202d, a fifth quantum node 202e, and a sixth quantum node 202f (collectively referred to as the quantum nodes 202). The quantum nodes 202 are positioned in different layers to form a three-dimensional quantum information processing architecture. Each quantum node integrates a combination of functional substructures—storage, operation, and routing—that collectively enable dynamic and modular assignment of functional roles without requiring physically distinct nodes dedicated to single tasks. For illustrative purposes, FIG. 2 may depict only the active substructures for a given illustrative node role, and other physically integrated substructures may be omitted from view.

For instance, the first quantum node 202a is configured to employ the associated storage substructure actively, thereby serving as a quantum memory element preserving quantum states with high fidelity. Additionally, first quantum node 202a utilizes the associated routing substructure to transmit stored quantum states to other nodes within the system, facilitating quantum communication pathways integral to network operation. Specifically, the first quantum node 202a can route quantum states to the second quantum node 202b, leveraging the routing functionality embedded in the architecture.

The second quantum node 202b exemplifies multifunctional adaptability by employing a storage substructure as a buffer for intermediate or ancillary quantum states generated or received during computation. Furthermore, the second quantum node 202b activates an operation substructure to perform quantum operations—including single- and multi-qubit gates—on the quantum states, functioning as a local processing unit within the system 200.

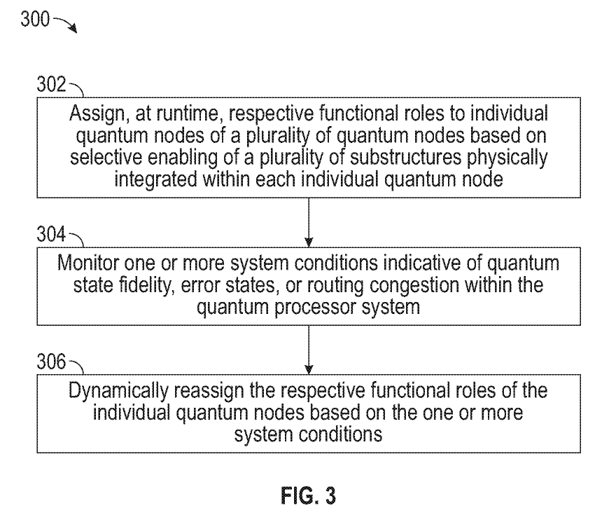

FIG. 3 depicts a flowchart of a method 300 for quantum computing, arranged in accordance with at least some embodiments of the present disclosure. The method 300 may be performed or controlled by a processor in, e.g., a computer and/or server coupled to the classical computing interface. In an example implementation, the method 300 may be performed in whole or in part by the system 100 of FIG. 1A. Some embodiments herein may include a non-transitory computer-readable storage medium that includes computer-executable instructions executable by a processor device to perform or control performance of any operations herein, such as the operations of the method 300 of FIG. 3. The method 300 may include one or more of blocks 302, 304, and/or 306.

At block 302, functional roles may be assigned to individual quantum nodes of a quantum processor system (e.g., the system 100 of FIG. 1A and/or the system 200 of FIG. 2) at runtime. In some embodiments, the functional roles may be assigned based on selective enabling of a substructures physically integrated within each individual quantum node. For example, each quantum node may include a storage substructure, an operation substructure, and a routing substructure. In instances a particular quantum node is assigned a storage role, at least the storage substructure of the particular quantum node is enabled for storing quantum states.

At block 304, one or more system conditions may be monitored. The one or more system conditions may include quantum state fidelity, error states, or routing congestion within the quantum processor system. Monitoring fidelity may involve evaluating the degree to which quantum states within the storage, operation, or routing substructures preserve intended coherence and purity over time. Degradation in fidelity may arise due to decoherence mechanisms, environmental noise, or imperfect gate operations. Measuring fidelity typically employs quantum tomography techniques, parity checks, or syndrome measurements facilitated locally within the operation substructure.

Detection of error states involves identifying occurrences of faults such as bit-flip, phase-flip, or other quantum errors within the physical qubits or control components of the quantum nodes. Error states may be revealed through syndrome extraction associated with quantum error correction codes (e.g., Shor or Steane codes), measurement of ancillary or parity qubits, or via feedback from embedded diagnostic sensors. Monitoring routing congestion assesses the quantum photonic traffic within the routing substructures and inter-node communication pathways. Congestion may manifest as increased photon loss, extended latency, or reduced bandwidth in photonic waveguides and couplers. It can result from high usage, component degradation, or localized faults. Measuring signal attenuation, photon correlation statistics, or routing path utilization metrics provides data to detect congestion.

At block 306, the respective functional roles of the individual quantum nodes may be reassigned based at least on the one or more system conditions. For example, in response to detection of monitored conditions, a control interface may issue configuration signals that selectively enable, disable, or time-multiplex the storage, operation, and routing substructures within individual quantum nodes, thereby altering the respective functional roles among storage, operation, routing, or combinations thereof. The reassignment may be achieved by reconfiguring internal coupling paths, adjustable optical switches, modulators, and isolation elements without physically relocating quantum states or modifying the physical structure of the nodes.

For example, in instances in which an operation substructure exhibits degraded gate fidelity or increased error rates, the quantum node may be reassigned from an operation role to a routing or storage role to maintain overall system reliability. Similarly, routing substructures encountering congestion or increased photon loss can prompt reassignment toward storage or operation roles, with photon paths adaptively rerouted through other nodes.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

For example, the method 300 may further include routing quantum states between the storage substructure, the operation substructure, and the routing substructure of each individual quantum node and between the plurality of quantum nodes based on the respective functional roles.

Within a single quantum node, configurable internal coupling paths and photonic waveguides permit quantum states to be selectively transferred among the storage, operation, and routing substructures. For example, quantum states stored in the storage substructure can be routed to the operation substructure for logic gate manipulation, or directed to the routing substructure for transmission to other quantum nodes. The routing substructure comprises low-loss optical waveguides, tunable couplers, and optical switches that dynamically guide photons in accordance with system control signals and monitored conditions, ensuring coherent state propagation with minimal loss or decoherence.

Between quantum nodes, photonic interconnects established via waveguides embedded along the double-helix or multi-layer architectures provide scalable, three-dimensional communication channels. Integrated couplers, dynamic electro-optic or thermo-optic modulators, and vertical couplers facilitate photon transitions across nodes and layers. Routing protocols adapt path selection and coupling strengths based on role assignments, workload demands, and real-time feedback, enabling optimized photon delivery to desired nodes or substructures for storage or computation.

As another example, the method 300 may further include identifying one or more individual quantum nodes that exhibit indications of degraded quantum state fidelity, the presence of error states, or increased routing congestion within the quantum processor system. The indications may be identified by analyzing monitoring data obtained from the storage, operation, and routing substructures of the quantum nodes, which may include measurements of coherence loss, error syndrome extraction, or photonic traffic metrics. In response to identifying such nodes as contributing to diminished performance or reliability, the quantum states may be rerouted to bypass the affected nodes. Rerouting may be performed by dynamically reconfiguring internal coupling paths, optical switches, and modulators within the routing substructures of neighboring quantum nodes to establish alternative photon transmission paths.

As yet another example, the method 300 may further include causing the respective functional roles of individual quantum nodes to transition during different time intervals, thereby enabling time-multiplexed operation of the multifunctional quantum nodes. The control signals may selectively activate or deactivate the storage, operation, and routing substructures within each quantum node in a coordinated temporal sequence. For instance, a quantum node may function as a storage element during one interval, preserving quantum states with high fidelity, and then switch to an operation role in a subsequent interval to perform quantum gates on the stored or incoming states. At other times, the node may assume a routing role, facilitating photon transmission between nodes or layers without engaging in processing or storage.

The foregoing specification is to be understood as being in every respect illustrative and exemplary, but not restrictive, and the scope of the invention disclosed herein is not to be determined from the specification, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

### ADDITIONAL EXAMPLES

Example 1: A quantum processor system comprising: a plurality of quantum nodes, each quantum node of the plurality of quantum nodes comprising: a storage substructure configured to maintain quantum states; an operation substructure configured to execute quantum operations with respect to the quantum states; and a routing substructure configured to direct the quantum states between the storage substructure, the operation substructure, and the plurality of quantum nodes.

Example 2: The quantum processor system of example 1, further comprising a plurality of photonic connections operatively coupled between individual quantum nodes of the plurality of quantum nodes.

Example 3: The quantum processor system of any of examples 1 or 2, wherein individual quantum nodes of the plurality of quantum nodes respectively assume respective functional roles based on enabling and disabling of one or more of the storage substructure, the operation substructure, and the routing substructure associated with the individual quantum nodes.

Example 4: The quantum processor system of example 3, wherein at least one individual quantum node of the plurality of quantum nodes dynamically switches between different functional roles during different time intervals.

Example 5: The quantum processor system of example 3, wherein a role of at least one individual quantum node of the plurality of quantum nodes is modified at runtime in response to a monitored condition indicative of one or more of an error state, degradation in quantum state fidelity, or congestion in quantum state routing.

Example 6: The quantum processor system of any of examples 1-5, wherein: the storage substructure comprises physically integrated quantum memory elements including at least one of an optical cavity, a photonic resonator, or a solid-state spin-based quantum memory; the operation substructure comprises physically integrated quantum control components including at least one of a phase modulator, a polarization controller, a beam splitter, or an interferometer; and the routing substructure comprises physically integrated photonic routing components including at least one of a waveguide, an optical switch, or a tunable coupler.

Example 7: The quantum processor system of any of examples 1-6, wherein the plurality of quantum nodes is arranged in a non-planar layout.

Example 8: The quantum processor system of example 7, wherein the routing substructure further comprises at least one inter-layer coupling element configured to route quantum states between different layers of the quantum processor system.

Example 9: The quantum processor system of any of examples 1-8, wherein quantum information is redundantly encoded across multiple individual quantum nodes of the plurality of quantum nodes.

Example 10: The quantum processor system of any of examples 1-9, wherein individual quantum nodes of the plurality of quantum nodes are capable of quantum state storage, quantum state manipulation, and quantum state routing without transfer of the quantum states to a separate physical quantum node.

Example 11: The quantum processor system of any of examples 1-10, further comprising a control interface configured to generate control signals for the plurality of quantum nodes.

Example 12: The quantum processor system of example 11, further comprising: an artificial intelligence (AI)-assisted control layer coupled to the control interface; and a token manager configured to: generate task tokens representative of quantum information processing tasks including at least one of a quantum storage request, a quantum computation request, or a quantum state routing request, distribute the task tokens to the plurality of quantum nodes, receive token status feedback from the plurality of quantum nodes, and, cause, based at least on system-level conditions and configuration guidance generated by the AI-assisted control layer, the control interface to generate the control signals to selectively enable, disable, or time-multiplex at least one of the storage substructure, the operation substructure, or the routing substructure of at least one quantum node.

Example 13: A method for operating a quantum processor system comprising: assigning, at runtime, respective functional roles to individual quantum nodes of a plurality of quantum nodes based on selective enabling of a plurality of substructures physically integrated within each individual quantum node; monitoring one or more system conditions indicative of quantum state fidelity, error states, or routing congestion within the quantum processor system; and dynamically reassigning the respective functional roles of the individual quantum nodes based on the one or more system conditions.

Example 14: The method for operating the quantum processor system of example 13, wherein the plurality of substructures includes a storage substructure, an operation substructure, and a routing substructure.

Example 15: The method for operating the quantum processor system of example 14, further comprising: routing quantum states between the storage substructure, the operation substructure, and the routing substructure of each individual quantum node and between the plurality of quantum nodes based on the respective functional roles.

Example 16: The method for operating the quantum processor system of any of examples 13-15, wherein the respective functional roles are reassigned by reconfiguring internal coupling paths, switches, or modulators associated with the plurality of substructures.

Example 17: The method for operating the quantum processor system of any of examples 13-16, further comprising: identifying one or more individual quantum nodes exhibiting indications of degraded quantum state fidelity, a presence of error states, or routing congestion; and rerouting the quantum states around the one or more individual quantum nodes.

Example 18: The method for operating the quantum processor system of any of examples 13-17, further comprising: causing the respective functional roles of the individual quantum nodes to transition during different time intervals.

Example 19: A quantum processor system comprising: a plurality of quantum nodes, each quantum node of the plurality of quantum nodes comprising: a storage substructure configured to maintain quantum states; an operation substructure configured to execute quantum operations with respect to the quantum states; and a routing substructure configured to direct the quantum states between (i) the storage substructure and the operation substructure within the quantum node and (ii) different quantum nodes of the plurality of quantum nodes; and a control interface communicatively coupled to the plurality of quantum nodes and configured to: receive monitoring information indicative of one or more system conditions including at least one of an error state, degradation in quantum state fidelity, or congestion in quantum state routing; generate control signals that assign, at runtime, respective functional roles to the plurality of quantum nodes by selectively enabling, disabling, and/or time-multiplexing at least one of the storage substructure, the operation substructure, or the routing substructure within each quantum node; and dynamically reassign, based at least on the monitoring information, at least one of the respective functional roles by adjusting the selectively enabling, disabling, and/or time-multiplexing of at least one of the storage substructure, the operation substructure, or the routing substructure within at least one quantum node.

Example 20: The quantum processor system of example 19, further comprising: an artificial intelligence (AI)-assisted control layer coupled to the control interface and a token manager configured to: generate and manage task tokens representative of quantum information processing tasks including at least one of a quantum storage request, a quantum computation request, or a quantum state routing request, distribute the task tokens to the plurality of quantum nodes, and receive token status feedback from the plurality of quantum nodes, wherein the AI-assisted control layer is configured to process system-level conditions and output configuration guidance that influences assignment, deferral, or redistribution of the task tokens among the plurality of quantum nodes and influences generation of the control signals.

Example 21: The quantum processor system of any of examples 7-8 wherein the non-planar layout comprises a three-dimensional curved pattern.

Example 22: The quantum processor system of example 21 wherein the three-dimensional curved pattern comprises a helical pattern.

Example 23: The quantum processor system of example 22 wherein the helical pattern comprises a dual-helix.

While the present disclosure has been particularly described with respect to the illustrated embodiments, it will be appreciated that various alterations, modifications, and adaptations may be made based on the disclosure and are intended to be within the scope of the disclosure. While the disclosure has been described in connection with what are presently considered to be the most practical and preferred embodiments, it is to be understood that the present disclosure is not limited to the disclosed embodiments but, on the contrary, is intended to cover various modifications and equivalent arrangements included within the scope of the underlying principles of the invention as described by the various embodiments referenced above and below.

1. A quantum processor system comprising:
a plurality of quantum nodes, each quantum node of the plurality of quantum nodes comprising:
a storage substructure configured to maintain quantum states;
an operation substructure configured to execute quantum operations with respect to the quantum states; and
a routing substructure configured to direct the quantum states between the storage substructure, the operation substructure, and the plurality of quantum nodes.

2. The quantum processor system of claim 1, further comprising a plurality of photonic connections operatively coupled between individual quantum nodes of the plurality of quantum nodes.

3. The quantum processor system of claim 1, wherein individual quantum nodes of the plurality of quantum nodes respectively assume respective functional roles based on enabling and disabling of one or more of the storage substructure, the operation substructure, and the routing substructure associated with the individual quantum nodes.

4. The quantum processor system of claim 3, wherein at least one individual quantum node of the plurality of quantum nodes dynamically switches between different functional roles during different time intervals.

5. The quantum processor system of claim 3, wherein a role of at least one individual quantum node of the plurality of quantum nodes is modified at runtime in response to a monitored condition indicative of one or more of an error state, degradation in quantum state fidelity, or congestion in quantum state routing.

6. The quantum processor system of claim 1, wherein:
the storage substructure comprises physically integrated quantum memory elements including at least one of an optical cavity, a photonic resonator, or a solid-state spin-based quantum memory;
the operation substructure comprises physically integrated quantum control components including at least one of a phase modulator, a polarization controller, a beam splitter, or an interferometer; and
the routing substructure comprises physically integrated photonic routing components including at least one of a waveguide, an optical switch, or a tunable coupler.

7. The quantum processor system of claim 1, wherein the plurality of quantum nodes is arranged in a non-planar layout.

8. The quantum processor system of claim 7, wherein the routing substructure further comprises at least one inter-layer coupling element configured to route quantum states between different layers of the quantum processor system.

9. The quantum processor system of claim 1, wherein quantum information is redundantly encoded across multiple individual quantum nodes of the plurality of quantum nodes.

10. The quantum processor system of claim 1, wherein individual quantum nodes of the plurality of quantum nodes are capable of quantum state storage, quantum state manipulation, and quantum state routing without transfer of the quantum states to a separate physical quantum node.

11. The quantum processor system of claim 1, further comprising a control interface configured to generate control signals for the plurality of quantum nodes.

12. The quantum processor system of claim 11, further comprising:
an artificial intelligence (AI)-assisted control layer coupled to the control interface; and
a token manager configured to:
generate task tokens representative of quantum information processing tasks including at least one of a quantum storage request, a quantum computation request, or a quantum state routing request,
distribute the task tokens to the plurality of quantum nodes,
receive token status feedback from the plurality of quantum nodes, and,
cause, based at least on system-level conditions and configuration guidance generated by the AI-assisted control layer, the control interface to generate the control signals to selectively enable, disable, or time-multiplex at least one of the storage substructure, the operation substructure, or the routing substructure of at least one quantum node.

13. A method for operating a quantum processor system comprising:
assigning, at runtime, respective functional roles to individual quantum nodes of a plurality of quantum nodes based on selective enabling of a plurality of substructures physically integrated within each individual quantum node;
monitoring one or more system conditions indicative of quantum state fidelity, error states, or routing congestion within the quantum processor system; and
dynamically reassigning the respective functional roles of the individual quantum nodes based on the one or more system conditions.

14. The method for operating the quantum processor system of claim 13, wherein the plurality of substructures includes a storage substructure, an operation substructure, and a routing substructure.

15. The method for operating the quantum processor system of claim 14, further comprising:
routing quantum states between the storage substructure, the operation substructure, and the routing substructure of each individual quantum node and between the plurality of quantum nodes based on the respective functional roles.

16. The method for operating the quantum processor system of claim 13, wherein the respective functional roles are reassigned by reconfiguring internal coupling paths, switches, or modulators associated with the plurality of substructures.

17. The method for operating the quantum processor system of claim 13, further comprising:
identifying one or more individual quantum nodes exhibiting indications of degraded quantum state fidelity, a presence of error states, or routing congestion; and
rerouting the quantum states around the one or more individual quantum nodes.

18. The method for operating the quantum processor system of claim 13, further comprising:
causing the respective functional roles of the individual quantum nodes to transition during different time intervals.

19. A quantum processor system comprising:
a plurality of quantum nodes, each quantum node of the plurality of quantum nodes comprising:
a storage substructure configured to maintain quantum states;
an operation substructure configured to execute quantum operations with respect to the quantum states; and
a routing substructure configured to direct the quantum states between (i) the storage substructure and the operation substructure within the quantum node and (ii) different quantum nodes of the plurality of quantum nodes; and
a control interface communicatively coupled to the plurality of quantum nodes and configured to:
receive monitoring information indicative of one or more system conditions including at least one of an error state, degradation in quantum state fidelity, or congestion in quantum state routing;
generate control signals that assign, at runtime, respective functional roles to the plurality of quantum nodes by selectively enabling, disabling, and/or time-multiplexing at least one of the storage substructure, the operation substructure, or the routing substructure within each quantum node; and
dynamically reassign, based at least on the monitoring information, at least one of the respective functional roles by adjusting the selectively enabling, disabling, and/or time-multiplexing of at least one of the storage substructure, the operation substructure, or the routing substructure within at least one quantum node.

20. The quantum processor system of claim 19, further comprising:
an artificial intelligence (AI)-assisted control layer coupled to the control interface and
a token manager configured to:
generate and manage task tokens representative of quantum information processing tasks including at least one of a quantum storage request, a quantum computation request, or a quantum state routing request,
distribute the task tokens to the plurality of quantum nodes, and receive token status feedback from the plurality of quantum nodes, wherein the AI-assisted control layer is configured to process system-level conditions and
output configuration guidance that influences assignment, deferral, or redistribution of the task tokens among the plurality of quantum nodes and influences generation of the control signals.
